(19) United States
(12) Patent Application Publication
(10) Pub. No.: US 2010/0237600 A1
(43) Pub. Date: Sep. 23, 2010

(54) BOOK STRUCTURE

(76) Inventor: Chanan Gardi, Firenze (IT)

Correspondence Address: MCGLEW & TUTTLE, PC, P.O. BOX 9227, SCARBOROUGH STATION, SCARBOROUGH, NY, 10510-9227, US

(21) Appl. No.: 12/682,396

(22) PCT Filed: Oct. 3, 2008
(86) PCT No.: PCT/IT08/00630

§ 371 Date: Jun. 11, 2010

(30) Foreign Application Priority Data
Oct. 12, 2007 (IT) BO2007A000686

(51) Int. Cl. B42D 1/00

(52) U.S. Cl. 281/38

(57) ABSTRACT

A book structure, or other publishing product consisting of a plurality of pages (31, 32, 33, 34) joined together and having a portion provided with an aperture with shaped profile (310, 320, 330, 340), the portions with holes of said pages being disposed for being superimposed when the corresponding pages (31, 32, 33, 34) of the book are overlapped; the size of the portion with aperture of each page (31, 32, 33, 34) is not lower than the size of the corresponding portion with aperture of the previous page and not greater than the size of the corresponding portion of the subsequent page,—furthermore, the structure is provided with a page (2), disposed on the bottom or subsequently in respect to the pages of said plurality; on said page (2) being disposed a plurality of superimposed flat elements (21, 22, 23, 24), the number of said flat elements corresponding to the number of the relevant pages (31, 32, 33, 34) which are superimposed to said lower page (2) and the thickness of said elements being substantially corresponding to the thickness of said pages (31, 32, 33, 34).

The invention regards the field of the publishing and, in particular, it relates to a book structure. The structure can be used for forming an editorial product, such as a children's book, a picture book, a scientific or geographic atlas, etc. . . . Are known books, especially for children, consisting of a plurality of pages in cardboard, plastic coated cardboard or plastic that have a rigidity and/or a thickness which is greater than the normal sheets of paper to allow a better handling and a greater wear resistance. In some cases, the pages have a number of holes which, when the book is closed, are stacked to provide a kind of three-dimensionality of all pages superimposed.

An aim of this invention is to provide a new book structure which, starting from the well-known concept of overlapping holes, can provide to the users, in an original and innovative way, a high interaction with the book itself, increasing the interest in it and making it more easily readable and usable according to many ways.

This result was reached in accordance with the invention adopting the idea to create a book structure with the characteristics described in claim 1. Other features are described in the dependant claims.

Among the advantages of this invention there are: it is possible to interact with the book in a comprehensive and attractive way for the readers, particularly when they are children; the structure is easily achievable and does not require special equipment for its manufacture, even by the publishing industry; the same structure can be achieved in different materials, not requiring the use only of a particular material.

Every technician who works in this field will better understand these advantages and further advantages and features of the present invention thanks to the following description and to the enclosed drawings as a practical exemplification which should not be considered in a limitative sense wherein:

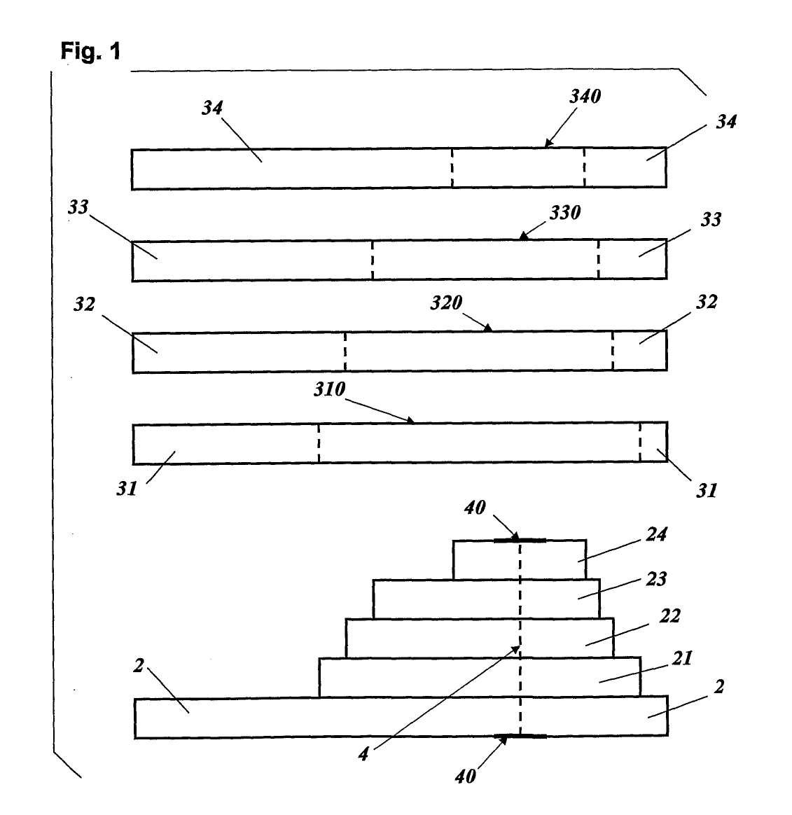

FIG. 1 is a schematic side view, not in scale, of a book structure produced according to the invention;

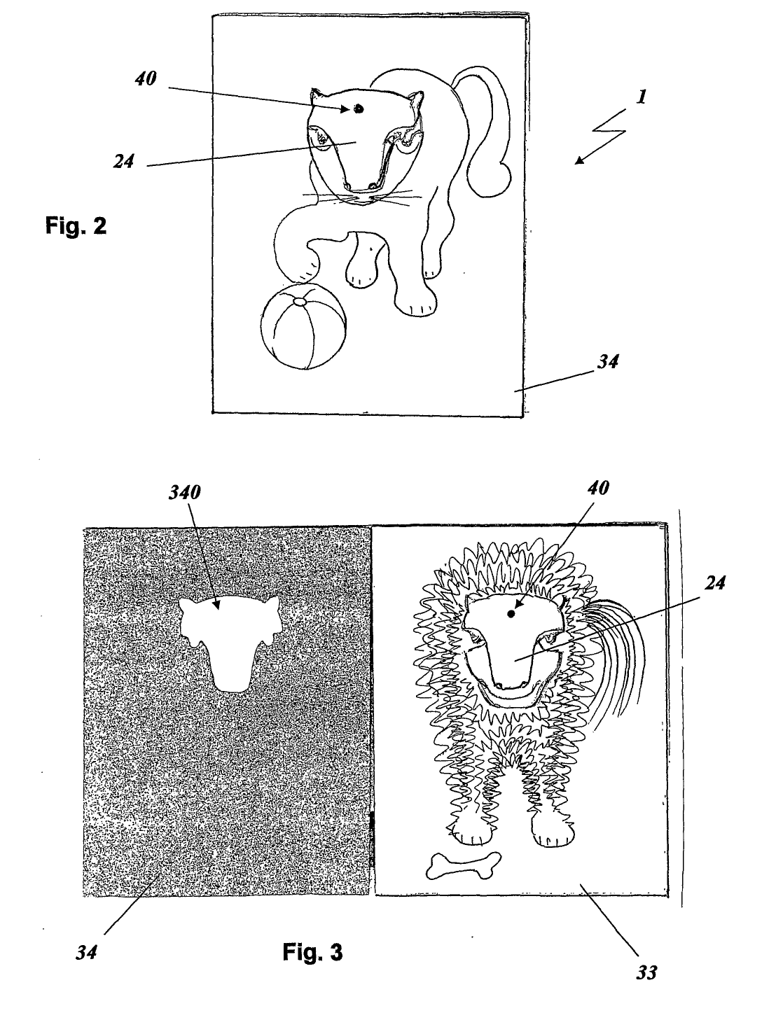

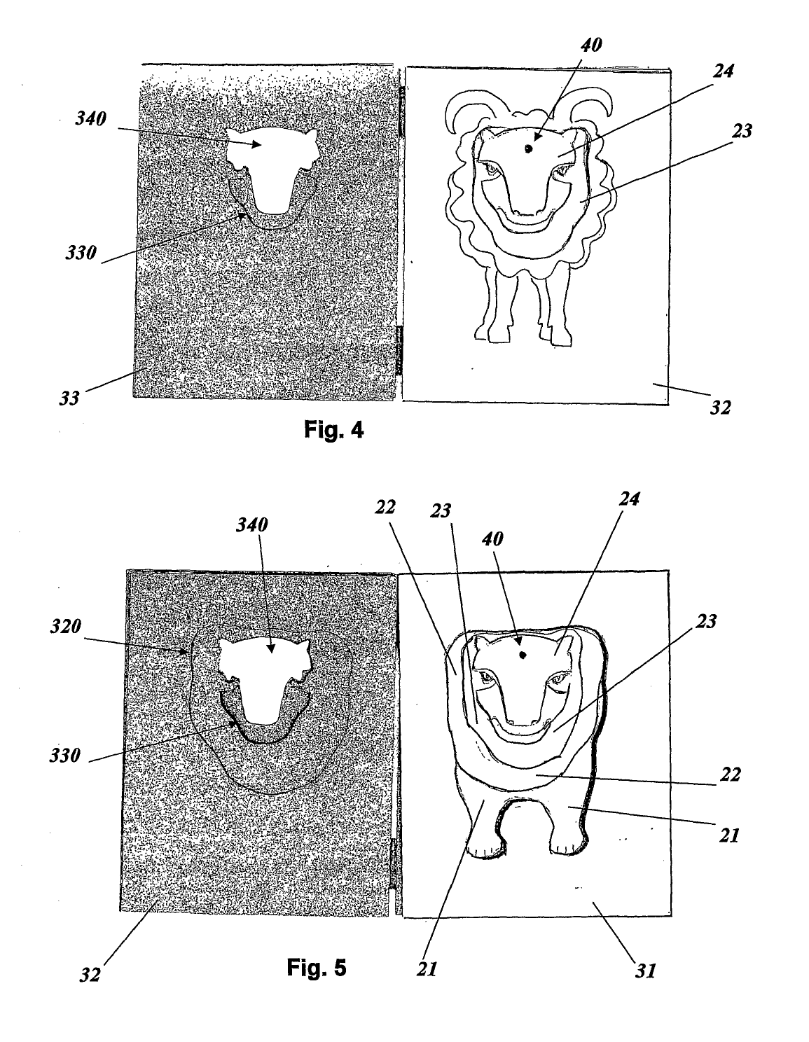

FIGS. 2-7 show in a schematic plan view of a possible example of a book structure produced according to the invention, visible in different configurations;

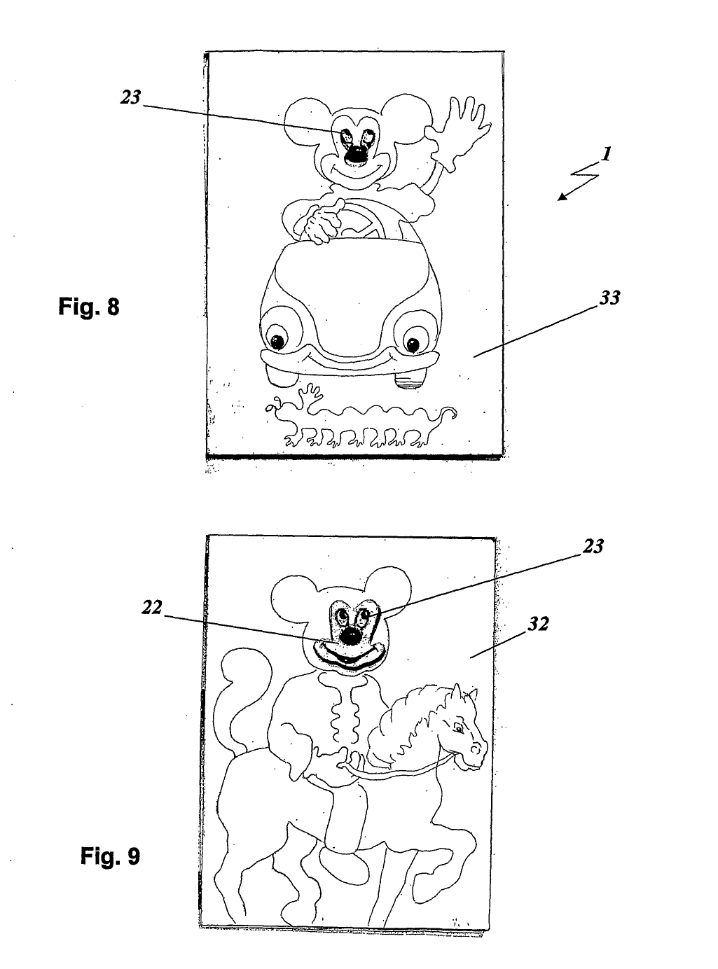

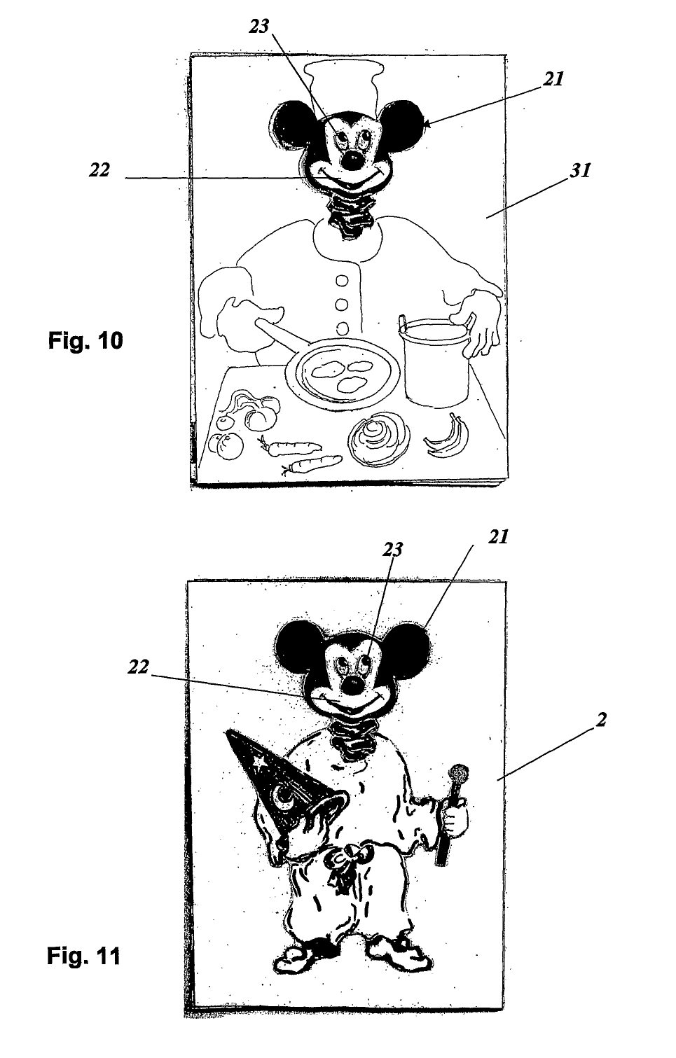

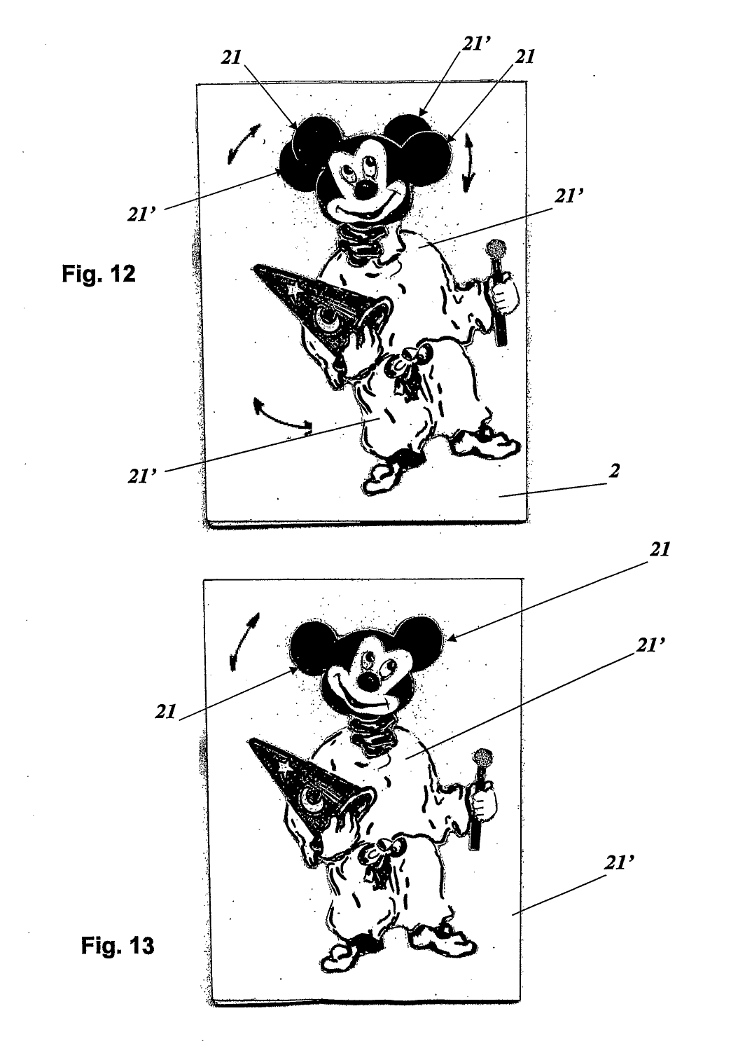

FIGS. 8-13 show in a schematic plan view of another possible example of a book structure produced according to the invention, visible in different configurations;

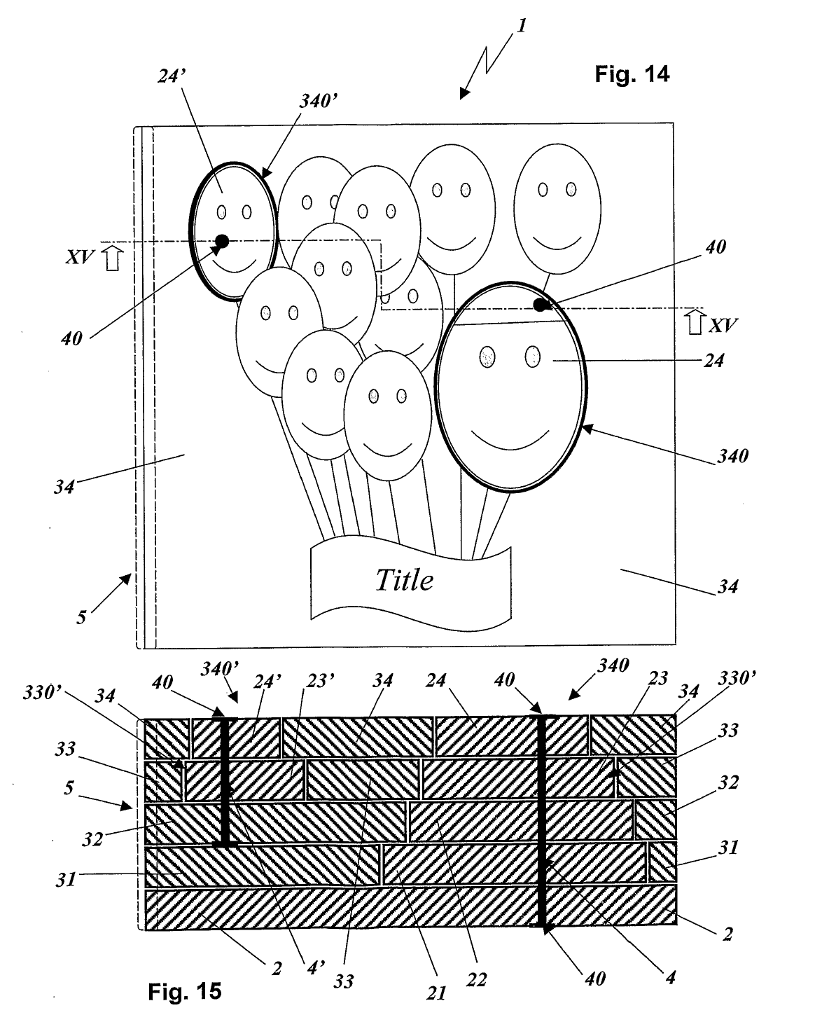

FIG. 14 is a schematic plan view of another embodiment of a book structure according to the invention;

FIG. 15 is a sectional view along the line XV-XV of FIG. 14.

In FIG. 1 the numeral references (31, 32, 33, 34) indicate the pages of a book (1) in accordance with the invention. In particular, the top page or first page, which can be the cover, is marked with (34). In the picture sizes are not in scale; in particular, the thickness of pages is oversized to better describe the invention. In addition, the pages are detached from each other and not bound as it is for a finished book. The structure (1) includes a plurality of pages (31, 32, 33, 34), provided with portions with a hole or aperture (310, 320, 330, 340), which are arranged to be superimposed one upon another when the corresponding pages (31, 32, 33, 34) of the book are superimposed. According to the invention, the size of the portion with aperture (310, 320, 330, 340) of each page (31, 32, 33, 34) is not lower than the size of the corresponding portion with aperture of the previous page and not greater than the size of the corresponding portion of the subsequent page. In particular, as illustrated in the examples, the hole of each page is larger than the corresponding hole of the previous page and smaller than the corresponding hole of the subsequent page. For example, with reference to FIG. 1, the portion with hole (320) of the page (32) may be smaller than the underlying portion (310) of the next page (31) and larger than the superimposing portion (330) of the superior page (33), which is the previous page (33) considering the reading direction of the book.

The structure (1) has a page (2) disposed at the bottom, that is subsequently to the other pages (of the plurality of pages which form the book) according to the reading direction of the book; on the page (2) is disposed a plurality of superimposed flat elements (21, 22, 23, 24); the number of these flat elements corresponds to the number of the pages (31, 32, 33, 34) which are superimposed to said page disposed on the bottom (2); said elements have a thickness which substantially corresponds to the thickness of said pages (31, 32, 33, 34).

In particular, the flat elements (21, 22, 23, 24) are pivoted around an axis perpendicular to the surface of the lower page (2). In correspondence of the fulcrum, the flat elements (21, 22, 23, 24) are crossed by a pin (4) perpendicular to the surface of the lower (2). The top and bottom of the pin (4) are marked with the reference (40) and have a flat shape. Referring to the examples, each of these flat elements (21, 22, 23, 24) has essentially the same profile and the same size of the relevant portion with hole (310, 320, 330, 340) of the correspondent page (31, 32, 33, 34).

In other words, each flat element matches with the corresponding portion with hole of the page. In this way, the portion with hole of each page, when coupled with the corresponding flat element, is filled by the same element, which has the same thickness. When the book is closed, the first page (or cover) has a even surface and the other pages are crossed by the flat elements overlapped with each other and connected to form a stack by the pivot (4).

Advantageously, the profile of said portions with holes (310, 320, 330, 340) is a part of a drawing or picture reproduced on the corresponding page (31, 32, 33, 34). In addition, the design reproduced on each of those elements not only completes the picture of the relevant page, but it is matchable with the design provided on other pages, so as to give rise to other designs combining with other pages. In other words, a picture can be formed using one or more flat elements combined with a page of the book.

This, as is evident from the examples of FIGS. 2 to 13, creates a kind of game by changing the disposition of the pages and of the, flat elements.

Another innovative feature of invention relates to the possibility of movement of the elements (21, 22, 23, 24), rotating around the axis (4), as indicated by the arrows in the examples. This feature gives another chance to ludic use of the structure of the book.

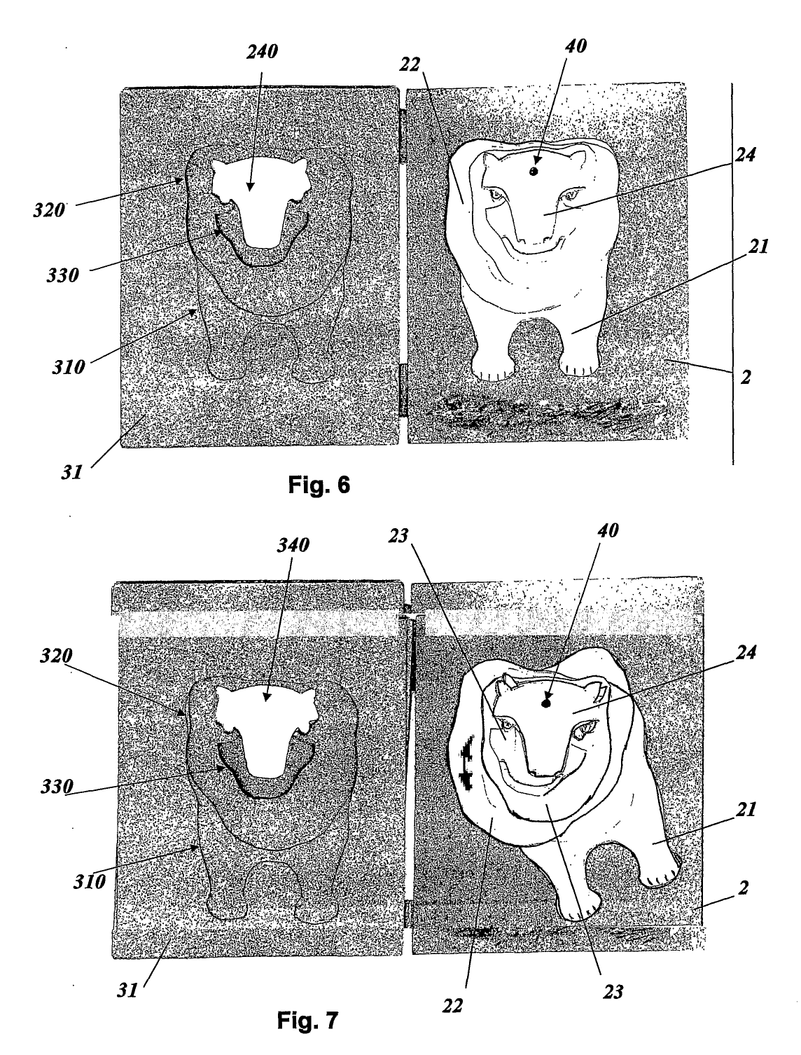

In FIGS. 2-7 the upper pages (31, 32, 33, 34) are four, as in the example of FIG. 1. FIGS. 6 and 7 show the possibilities of moving the flat elements, with rotation around the pivot (4).

In FIGS. 8-13 the structure (1) has three upper pages (31, 32, 33) and one lower or last page(2). FIGS. 11-13 show the possibilities of moving the flat elements. In this example, there are many flat elements (21′) added to the only flat element (21) provided of the examples above. In this embodiment, on the lower page (2) are fixed many flat elements (21′) in addition to the element (21). Of course, to enable the overlapping of the flat elements (21, 21′), the total thickness of the flat elements (21, 21′) will be equal to the thickness of the relevant page (page 31 in this case).

Also in FIGS. 14-15 the pages of a book (1) according to the invention are marked with (31, 32, 33, 34). In particular, the top page or front page (which may form the cover) is marked with (34). Also in this case, the dimensions are not in scale, in particular the thickness of pages is oversized to better describe the invention.

The pages are bound with one another to form a book by a back or spine (5) schematically represented by a rectangular figure in discontinuous line.

According to the example shown in FIGS. 14-15, on an intermediate page (32) of the plurality of pages (31, 32, 33, 34) there is a second plurality of, overlapping flat elements (23′, 24′); the number of said second plurality of flat elements are the same of the number of the corresponding pages (33, 34) which are superimposed on said intermediate page (32); said flat elements (23′, 24′) have a thickness substantially corresponding to the thickness of those pages (33, 34). In practice, a pivot (4′) is fixed to the intermediate page (32) and said additional flat elements (23′, 24′) are pivoted around said pivot (4′). When the structure of the book (1) is closed, as schematically shown in FIG. 15, the flat element (23′) is inserted into the aperture (330′) of the page (33); similarly, the flat element (24′) is inserted into the aperture (340′) of the page (34), that is the page disposed in the top. Said page (34) may be the cover of the book and in FIG. 14 has a box for the title and a design formed, in part, by the two flat elements (24) and (24′), which are at the same height of this page (34).

In this embodiment, the other flat elements (21, 22, 23, 24) are pivoted to the pin (4), which is fixed to the last page (2). The top and bottom of the pin (4), which have a flat shape, are marked with the reference (40)

In practice, the execution details may vary as regards the shape the size, the arrangement of the elements, the kind of material used, but they are within the limits of the solution adopted and within the limits of the protection offered by the present patent.

1. A book structure, or other publishing product, the structure comprising:
a plurality of pages joined together and having a portion provided with an aperture with shaped profile, the portions with apertures of said pages being disposed for being superimposed when corresponding pages of the book are overlapped, wherein a size of the portion with aperture of each page is not lower than a size of a corresponding portion with aperture of a previous page and not greater than a size of a corresponding portion of a subsequent page; and
a lower page, disposed on the bottom or subsequently in respect to the pages of said plurality of pages;
a plurality of superimposed flat elements disposed on said lower page, wherein a number of said flat elements corresponds to a number of said plurality of pages which are superimposed to said lower page and a thickness of said elements substantially corresponds to a thickness of said plurality of pages.

2. A structure according to claim 1, wherein said flat elements are pivoted around an axis perpendicular to a surface of the lower page.

3. A structure according to claim 1, wherein each of said flat elements has essentially the same profile and same size of the aperture of the corresponding page.

4. A structure according to claim 1, wherein the aperture of each page is larger than the corresponding aperture of the previous page and smaller than the corresponding aperture of the subsequent page.

5. A structure according to claim 1, wherein the profile of said portions with apertures is a part of a drawing reproduced on the corresponding page.

6. A structure according to claim 1, wherein the profile of said portions with apertures is a part of a drawing reproduced on the corresponding page, the design of each of said elements being matchable with the design provided on other pages, so as to define other designs combining itself with other pages.

7. A structure according to claim 2, wherein said flat elements are crossed by a pin perpendicular to a surface of the lower page.

8. A structure according to claim 1, wherein on an intermediate page of said plurality of pages is disposed a second plurality of overlapping flat elements, wherein a number of said second plurality of said elements corresponds to the number of the corresponding pages superimposed to said intermediate page (32) and a thickness of said second plurality of said elements substantially corresponds to the thickness of said pages.
